(19) United States
(12) Patent Application Publication
(10) Pub. No.: US 2020/0141262 A1
(43) Pub. Date: May 7, 2020

(54) ENGINE WITH TEMPERATURE SENSOR IN A FLOW PATH OF A FLOW CARRYING FLUID AT A HIGHER TEMPERATURE IN THE EVENT OF A FAULT, AND METHOD FOR THE ELECTRONIC DETECTION OF A FAULT DURING OPERATION OF AN ENGINE

(71) Applicant: Rolls-Royce Deutschland Ltd & Co KG, Blankenfelde-Mahlow (DE)

(72) Inventors: Sebastian SCHREWE, Berlin (DE); Michael FRIEDRICH, Schwielowsee (DE)

(21) Appl. No.: 16/560,446

(22) Filed: Sep. 4, 2019

(30) Foreign Application Priority Data
Sep. 5, 2018 (DE) 10 2018 215 078.8

(51) Int. Cl. F01D 17/08; F02C 9/20

(52) U.S. Cl. CPC F01D 17/085; F05D 2270/303; F02C 9/20

(57) ABSTRACT

The proposed solution relates in particular to an engine having
at least one flow-guiding element within the engine, via which, during malfunction-free operation of the engine, at least one target flow of fluid is conducted along a first flow direction and via which, in the event of a malfunction within the engine, a fault flow of fluid of a higher temperature than the fluid of the target flow is conducted along a second flow direction, which differs from the first flow direction, and
at least one temperature sensor which is situated in a flow path both of the target flow and of the fault flow.

This application claims priority to German Patent Application DE102018215078.8 filed Sep. 5, 2018, the entirety of which is incorporated by reference herein.

The proposed solution relates to an engine having at least one temperature sensor in a flow path of a flow which guides fluid of a relatively high temperature in the event of a fault, and to a method for the electronic detection of a malfunction during the operation of an engine.

It is widely known that any malfunctions during the operation of an engine must be able to be detected quickly and with a high level of reliability in order, in particular during flight, to be able to react in a timely manner to any malfunctions at the engine and to be able to correspondingly alert in particular a pilot of the aircraft equipped with the engine. It is often the case that any malfunctions during the operation of the engine are not readily detectable by sensor, and so components are generally designed in an elaborate and cost-intensive manner for tolerating even relatively major faults over a particular period of time. This concerns in particular malfunctions with any sealing or cooling of highly loaded components by corresponding air flows within an engine. If any flows used for sealing or cooling are completely or partly withdrawn, this can lead to a relatively quick temperature-induced failure of highly loaded components and thus to the failure of the engine. In this case, even relatively small increases in the temperature can have a decisive influence on the reduction of the service lives of components of the engine.

There is thus a need for an engine which is improved in this respect and in particular a method for the electronic detection of a malfunction during the operation of an engine.

Said object is achieved both by an engine according to claim 1 and by a method according to claim 15.

According to a first aspect of the proposed solution, provision is made of an engine comprising at least one flow-guiding element within the engine, via which, during malfunction-free operation of the engine, at least one target flow of fluid is conducted along a first flow direction and via which, in the event of a malfunction within the engine, a fault flow of fluid of a higher temperature than the fluid of the target flow is conducted along a second flow direction, which differs from the first flow direction. The engine furthermore comprises at least one temperature sensor which is situated in a flow path both of the target flow and of the fault flow.

The proposed solution is based here on the fundamental concept that any malfunction or fault situation can be detected with relatively high accuracy via the positioning of at least one temperature sensor in a flow path along which both a target flow and a fault flow with a different flow direction are conducted. Thus, in the case of the proposed solution, associated with any fault during the operation of the engine is not only an increase in temperature but also a switch in direction of the fluid flow flowing past the at least one temperature sensor. Here, use is made of the fact that, at least for particular malfunctions within the engine, changed pressure conditions are the result, which, in comparison with normal operation, lead at least locally to changed fluid flows. Via the pressure conditions which have changed due to a malfunction, it is then the case for example that fluid is guided past the at least one temperature sensor from a relatively hot region within the engine, whereby a clearly measurable jump in temperature is obtained in the event of a malfunction.

Consequently, in the case of the proposed solution, the at least one temperature sensor is positioned in a flow path along which both the target flow and the fault flow are conducted with the aid of the at least one flow-guiding element, such that fluid flows past the at least one temperature sensor not only along the first flow direction during malfunction-free operation of the engine. Rather, the at least one temperature sensor is positioned such that, in any malfunction or fault situation, it is then also (instead) the case that fluid which flows along another, second flow direction and has a higher temperature than the fluid of the target flow flows past the at least one temperature sensor. Consequently, a measurable jump in temperature, for example by several dozen or even by several hundred Kelvin, is obtained as a result of the switch from the target flow to the fault flow and thus as a result of the associated switch in direction of the fluid flow guided past the at least one temperature sensor. Consequently, therefore, a changed temperature or a rise in temperature is measurable in dependence on whether the target flow or a fault flow is guided past the temperature sensor.

In principle, the at least one temperature sensor may be positioned at or in the at least one flow-guiding element. The at least one temperature sensor is thus positioned for example within a space formed in the flow-guiding element, or after an inlet opening or outflow opening of the flow-guiding element, via which inlet opening or outflow opening for example the target flow flows into the flow-guiding element and a fault flow flows out of the flow-guiding element.

The flow-guiding element may in principle be designed to guide the fault flow past the at least one temperature sensor along a second flow direction, which is opposite the first flow direction of the target flow. In a design variant based on this, the target flow thus flows past the at least one temperature sensor with the relatively cold fluid along a first flow direction, while a fault flow flows past the at least one temperature sensor with relatively warm/relatively hot fluid along a second flow direction, which is opposite said first flow direction.

In a design variant, the at least one flow-guiding element is formed with at least one flow duct via which the target flow and/or the fault flow are/is diverted at least once. A diversion of the respective flow can be an advantage in particular for conducting the respective flow, in particular a fault flow of relatively hot fluid, away from thermally less highly loadable components of the engine.

In a design variant, the at least one flow-guiding element is provided in the region of a stator of a turbine of the engine, in particular in the region of a turbine inlet stator or of a high-pressure turbine stator. The proposed solution can be an advantage in particular in the region of a stator of a turbine of the engine that generates the drive energy, since here, the withdrawal of any cooling and/or sealing flows is generally particularly critical and, by detecting by sensor any malfunctions in said region during the operation of the engine as reliably as possible, serious damage of the engine can be avoided. Here, the at least one flow-guiding element may be configured and provided for example for conducting a target flow which originates from compressor bleed air fed to the turbine and which is guided from the outside in the direction of an inner part of the turbine. Here, the compressor bleed air is used for example for the cooling of guide vanes and/or rotor blades or rotor disks of the turbine and/or for the sealing of edge regions or bearings at the turbine.

If a corresponding cooling-air flow or sealing-air flow is reduced owing to a malfunction within the engine, for example owing to a malfunction at a bleed-air valve which controls the feeding, or is even completely withdrawn, this can lead to major, function-impairing damage of the engine. With regard to a design variant of the proposed solution, use is made in this respect for example of the fact that any reduction of the corresponding fed cooling-air flow or sealing-air flow in the region of a stator of the turbine can lead to a change in the (local) pressure conditions, and that consequently a fault flow not present during normal operation is then formed, said fault flow carrying along fluid of a higher temperature than the target flow present during normal operation of the engine. In this case, the fault flow flows in a (second) flow direction which is different from the (first) flow direction of the target flow, owing to the changed pressure conditions.

In a design variant, via the at least one flow-guiding element, the target flow is conducted from a hollow space, which is bordered at least partially by the stator, in the direction of an annular space of the engine, in which at least one guide vane of the stator is arranged. During normal operation of the engine, the target flow is thus guided in the direction of an annular space of the engine via the flow-guiding element. Consequently here, relatively cool fluid is conducted to the annular space in a pressure-driven manner via the flow-guiding element. If changed pressure conditions arise owing to a malfunction in the engine, the flow-guiding element is, in such a design variant, correspondingly positioned such that a fault flow then carries along hot or relatively hot fluid from the annular space in the direction of a hollow space of the stator. Here, in comparison with the target flow, a clearly measurable jump in temperature occurs at the temperature sensor. In this way, it is consequently possible to readily infer in a reliable manner any malfunction situation, possibly in a manner dependent on the magnitude of the jump in temperature, even the type and/or category of the malfunction situation.

The hollow space which is bordered at least partially by the stator may be formed for example in the interior of the guide vane. For example, a vane chamber of a guide vane of the stator is involved here, through which vane chamber air is conducted from the outside in the direction of the interior of the turbine for cooling and/or sealing purposes.

Alternatively or in addition, the hollow space may be formed at least partially between a platform of the stator and a section of a housing to which the stator is fixed. A corresponding platform of the stator is understood to mean in this context in particular a foot plate or a head plate of a guide vane of the stator.

Regardless of the type of hollow space, this may be connected to a feed duct (for example in the form of a feed pipe) via which, during the operation of the engine, fluid is fed, in particular for cooling and/or sealing purposes, to the hollow space. In this case, the flow-guiding element is then configured to conduct a fault flow, which is formed, along the second flow direction if the quantity of the fluid fed via the at least one feed duct drops below a threshold value. Such a fault flow, which is guided past the at least one temperature sensor via the flow-guiding element, is formed for example if the feed duct, or at least one feed duct of multiple feed ducts feeding fluid to the hollow space during malfunction-free operation, is damaged or a valve within a feed duct does not function correctly. As a result of this, a pressure in the hollow space of the stator then decreases and, for example, drops below a pressure within the hot fluid-guiding annular space of the engine, with the result that there is no longer fluid of a target flow flowing in the direction of the annular space, but rather the then higher pressure in the annular space allows hotter fluid to flow past the temperature sensor in the direction of the stator-side hollow space.

In order to be able to allow fluid to flow from the annular space in the direction of the stator-side hollow space in any fault situation, an opening via which fluid is able to flow into the annular space and/or out of the annular space is provided at a radially outer platform of the stator (and thus for example at a head plate of a guide vane of the stator), at a radially inner platform of the stator (and thus for example at a foot plate of a guide vane of the stator) and/or at a guide vane of the stator itself. In the last-mentioned case, a corresponding opening for a fluidic connection to the annular space may be provided on a suction side or pressure side of a guide vane.

A duct of the at least one flow-guiding element, which duct adjoins a corresponding opening, then opens for example into a platform-side radially outer or radially inner cavity in the region of a guide vane of the stator or in a vane chamber within a guide vane of the stator. The at least one temperature sensor may therefore be positioned in particular in a section of such a duct, or for example within the respective hollow space in the immediate vicinity of a hollow space-side opening of the duct, via which opening the target flow is able to flow in the direction of the annular space and, conversely, from the annular space into the hollow space.

In a design variant, the at least one flow-guiding element forms a chamber and/or a throttle section. If the flow-guiding element is formed with a chamber and/or a throttle section, this may, in a design variant, serve for maintaining an intermediate pressure within the flow-guiding element during operation of the engine, which intermediate pressure is higher than a pressure in the annular space, but in this case only to a relatively small extent in comparison with the pressure which prevails in the hollow space which is bordered at least partially by the stator. It is thus possible via an additional chamber and/or a throttle section at the flow-guiding element for an intermediate pressure to be predefined, which intermediate pressure, though it is lower in comparison with the pressure in the stator-side hollow space, still ensures a sufficient pressure gradient with respect to the pressure in the annular space in order, during malfunction-free operation of the engine, to generate the target flow in the direction of the annular space. However, this pressure gradient which drives the target flow is then for example relatively small and can—in the event of a malfunction in the feeding into the hollow space—(more) easily become negative. The fault flow, which conveys relatively warm fluid from the annular space in the direction of the hollow space, is thus already formed at an early stage, that is to say already with a relatively small change to the inflow (in comparison with a flow-guiding element without an additional chamber and/or without an additional throttle section). It is furthermore also possible via an additional chamber and/or an additional throttle section at the at least one flow-guiding element for a throughflow quantity of fluid to be able to be predefined in a more targeted manner both for the target flow and for a fault flow. A relatively small throughflow quantity is advantageous in this regard in particular if the target flow is branched off from a flow, used for cooling and/or for sealing, in the region of the stator for the fault detection and is fed to the temperature sensor. The smaller the branched-off target flow is, the smaller a possibly negative influence on the corresponding cooling- and/or sealing-air flow can also be kept during normal operation of the engine.

In a design variant, the at least one flow-guiding element is formed integrally on a guide vane of the stator. Here, said design variant includes in particular a corresponding flow-guiding element being formed on a platform of the stator and/or in a guide vane of the stator or being molded onto a platform of the stator, for example by means of welding.

In an alternative design variant, the at least one flow-guiding element is provided at a borescope opening. In this variant, use is consequently made of a borescope opening which is to be formed, or is already formed, at the engine in any case, and use is made of said borescope opening for the attachment of the flow-guiding element and thus of the at least one temperature sensor. In this case, the flow-guiding element may, for example, be inserted at a borescope opening, which is provided anyway, at a later stage. In particular, the flow-guiding element may be provided at a borescope opening at a turbine housing in the region of a stator.

The use of a provided borescope opening for at least one flow-guiding element can, for example, significantly reduce any modifications to hitherto used structural types of a stator for the implementation of a design variant of the proposed solution. In the borescope opening, it is merely necessary to position a correspondingly designed flow-guiding element with a temperature sensor at a later stage, wherein, by the position of the borescope opening at the stator, it should of course be ensured that, in the event of any withdrawal, even only in part, of a cooling-air and/or sealing flow in the region of the borescope opening, it is indeed also the case that a sufficient change in the pressure conditions, which change locally influences the flow conditions, occurs.

A further aspect of the proposed solution relates to a method for the electronic detection of a malfunction during the operation of an engine.

Here, at least one temperature sensor is positioned within the engine in a flow path along which, during malfunction-free operation of the engine, at least one target flow of fluid flows along a first flow direction and along which, in the event of a malfunction within the engine, a fault flow of fluid of a higher temperature than the fluid of the target flow flows along a second flow direction, which differs from the first flow direction. By way of a switch from the target flow to the fault flow and an associated jump in temperature which occurs at the at least one temperature sensor, a malfunction is then detected electronically with the aid of the temperature sensor.

In the proposed method, use is consequently likewise made of the fact that a measured temperature or a measured (characteristic) rise in temperature at the temperature sensor allows conclusions to be drawn about a switch in the direction of the fluid flow flowing past the temperature sensor and about a possibly occurring malfunction, possibly even the type or category thereof.

The at least one temperature sensor is coupled for example to electronic evaluation logic means for the automated evaluation of the measured temperature and/or a measured rise in temperature. It is possible for example for concordance data to be stored in the electronic evaluation logic means, via which different temperature values or rises in temperature are assigned to different faults or risk levels. In this way, it is possible for example for different types of alarm signals to be generated via the evaluation logic means in a manner dependent on the magnitude of a measured temperature or of a measured rise in temperature.

It goes without saying that a design variant of a proposed method is able to be carried out at a design variant of a proposed engine. Advantages and features mentioned above and below for design variants of a proposed engine thus also apply to design variants of a proposed detection method, and vice versa. In particular, the method for the electronic detection of a malfunction may be provided for an application in the region of a stator of a turbine of the engine, and consequently for the measurement of the temperature or a rise in temperature with the aid of the at least one temperature sensor in the region of such a stator.

The appended figures illustrate exemplary possible design variants of the proposed solution.

In the figures:

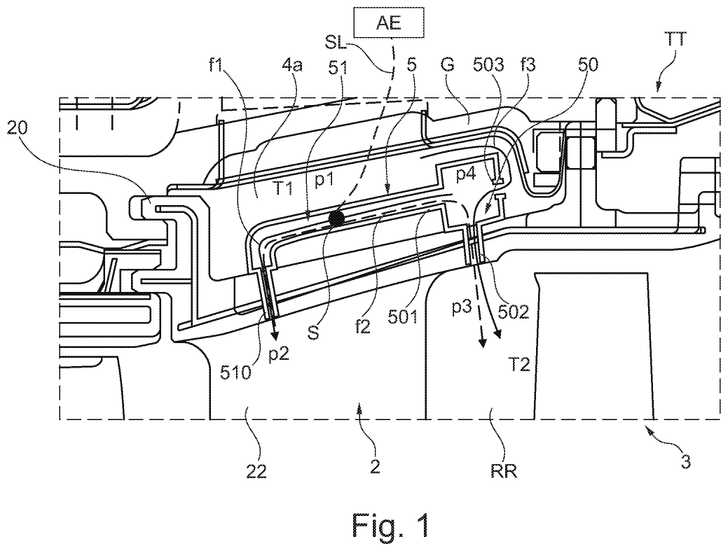

FIG. 1 shows, in a detail, a high-pressure turbine in the region of a stator with a view directed toward a platform cavity, with a flow-guiding element in the region of a head plate of a guide vane of the stator;

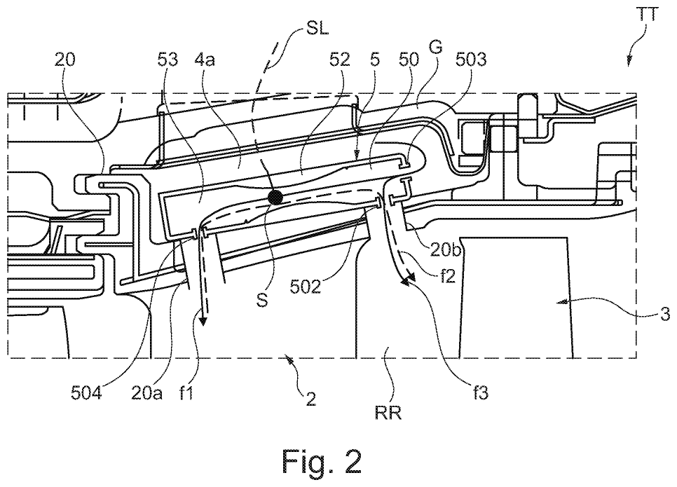

FIG. 2 shows, in a view corresponding to FIG. 1, a further design variant with an alternatively designed flow-guiding element, which comprises a throttle section;

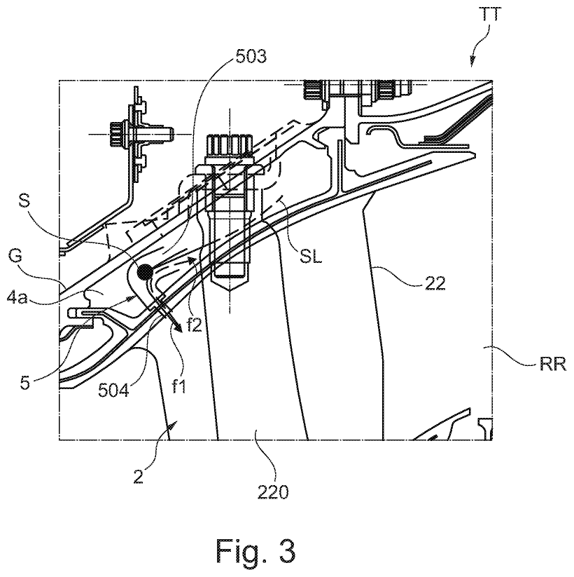

FIG. 3 shows, in a sectioned view, a flow-guiding element in the region of a turbine inlet stator at a head plate of a guide vane of the stator;

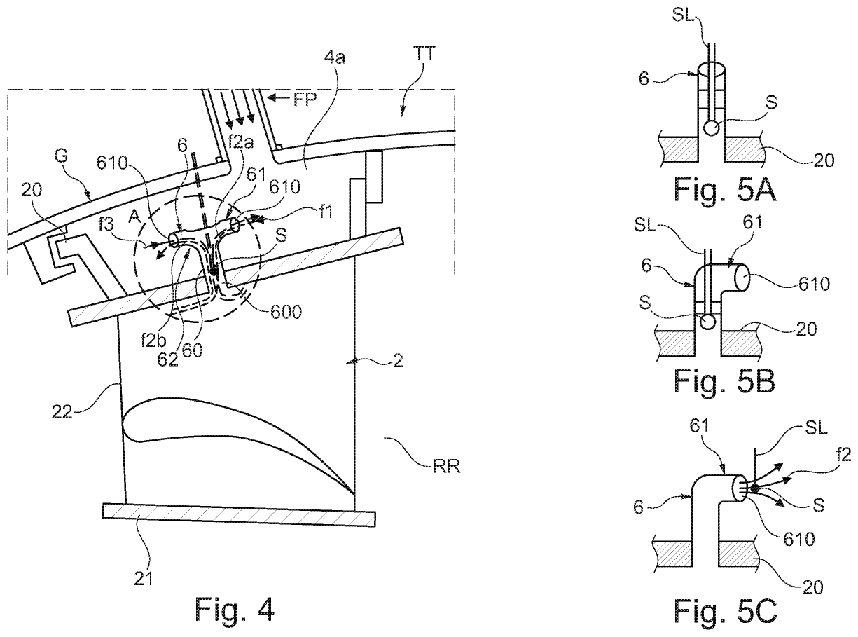

FIG. 4 shows, schematically and in a sectioned view, a further design variant with a T-shaped flow-guiding element at a head plate of a guide vane of a stator for a turbine of an engine;

FIGS. 5A-5C show, on an enlarged scale, different further design variants for a flow-guiding element in FIG. 4;

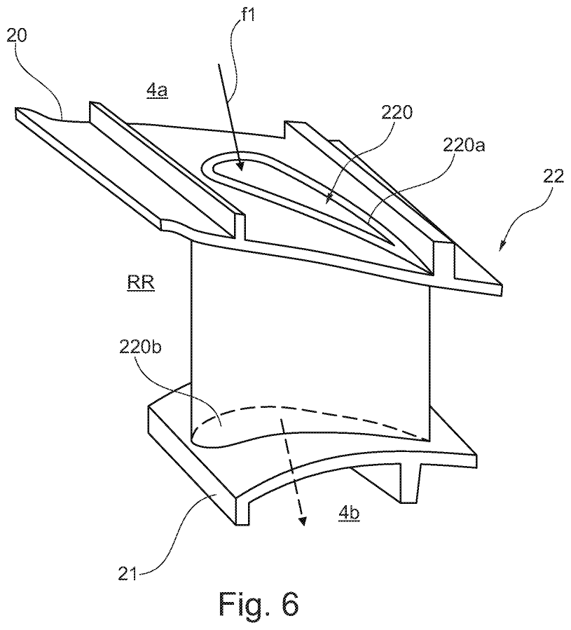

FIG. 6 shows, in a schematic view and in an individual illustration, a guide vane of a stator with a continuous vane chamber for the guidance of a cooling-air flow;

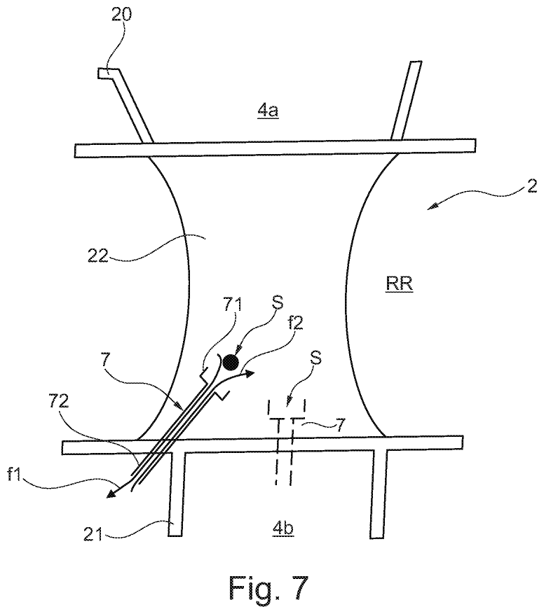

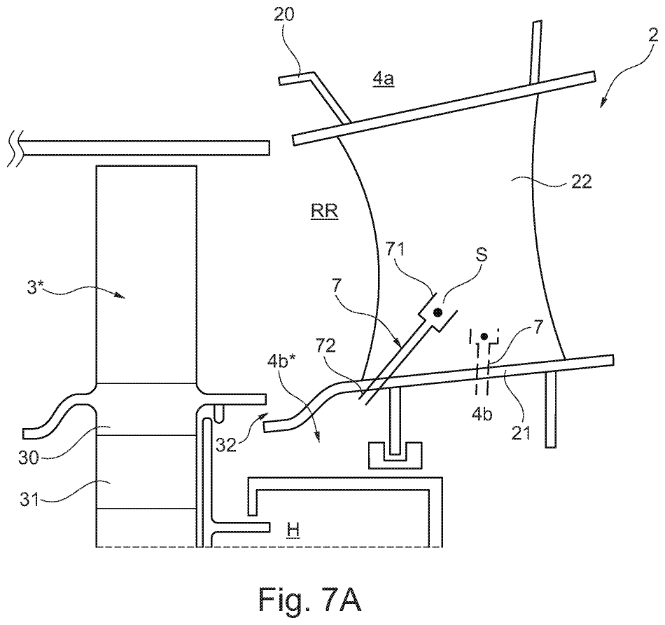

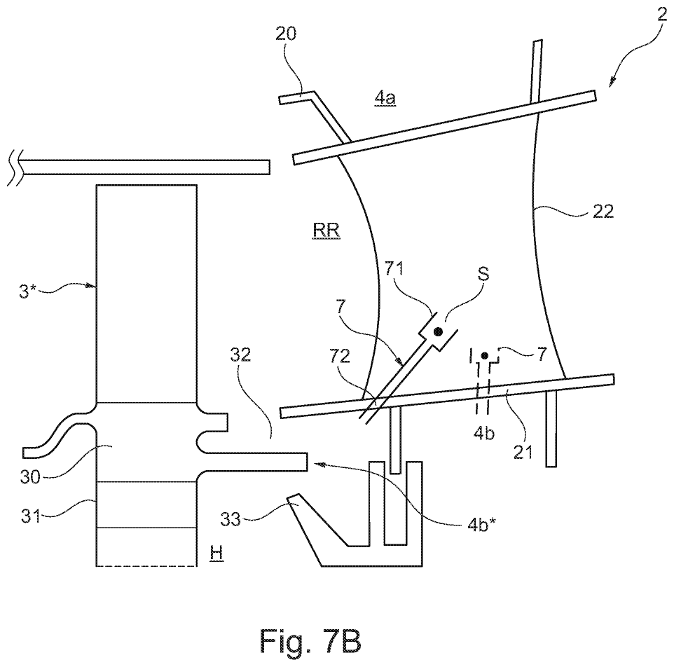

FIG. 7 shows, schematically and in a side view, a guide vane with two variants of a flow-guiding element via which in each case one fluidic connection is provided between a stator-side cavity and a vane chamber;

FIGS. 7A-7B show refinements of the design variants in FIG. 7 with an illustration of a Jenkinson cavity or rotor pressure-damping cavity;

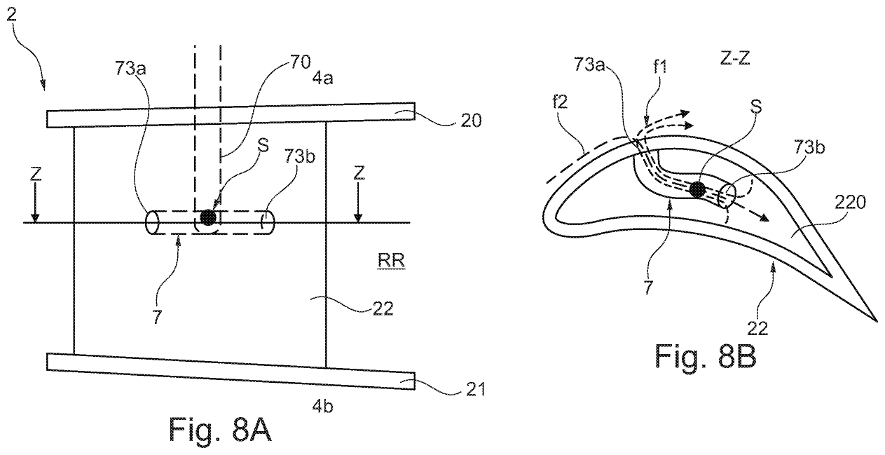

FIGS. 8A-8B show different views of a design variant in which a fluidic connection is provided between an annular space and an inner vane chamber of a guide vane via a flow-guiding element, and an opening in the flow-guiding element is provided on a suction side of the guide vane;

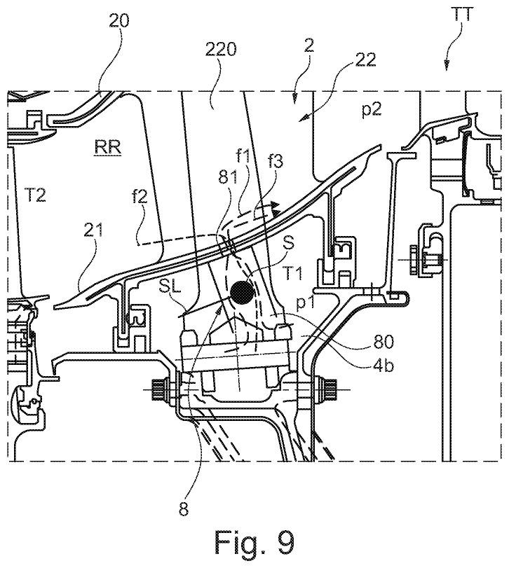

FIG. 9 shows, in a detail, a turbine of an engine with a view directed toward a guide vane of a stator, in which a flow-guiding element is provided in the region of a foot plate of the guide vane;

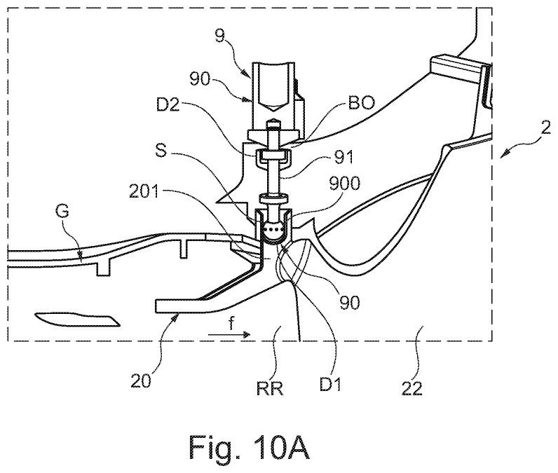

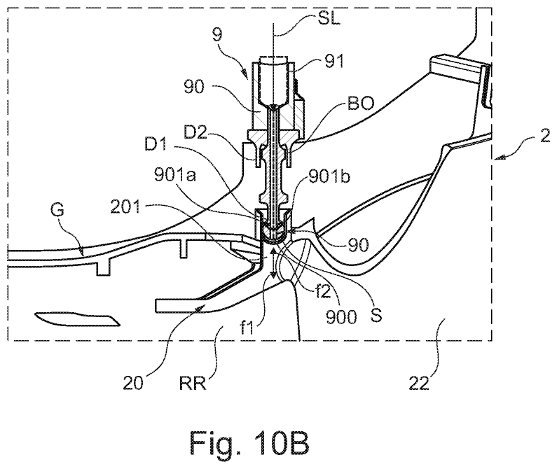

FIGS. 10A-10B show, in different views, a further design variant, in which a flow-guiding element is provided at a borescope opening in the region of a guide vane of a stator of a turbine;

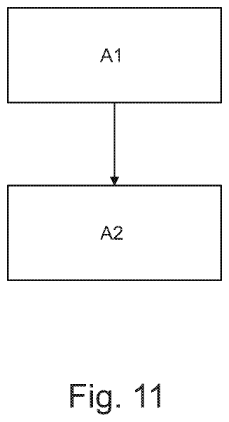

FIG. 11 shows, schematically, a flow diagram for a design variant of a proposed detection method;

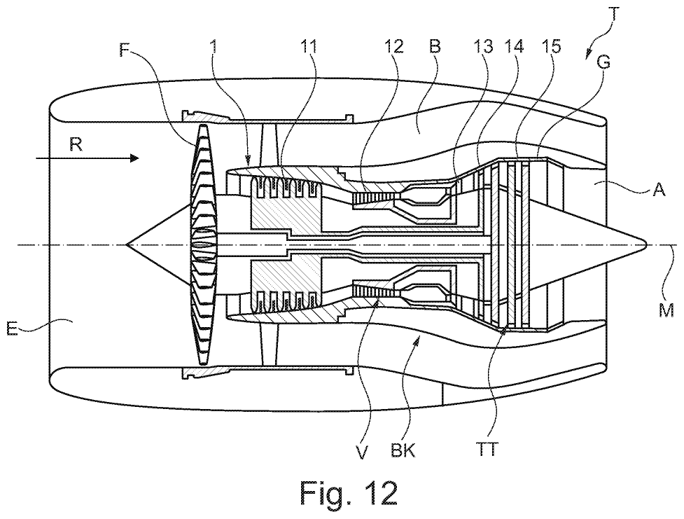

FIG. 12 shows, schematically in a sectional illustration, a gas turbine engine.

FIG. 12 illustrates, schematically and in a sectional illustration, a (gas turbine) engine T in the form of a turbofan engine, in which the individual engine components are arranged one behind the other along a central axis or axis of rotation M. At an inlet or intake E of the engine T, air is drawn in along an inlet direction E by means of a fan F. This fan F is driven via a connecting shaft, which is set in rotation by a turbine TT. Here, the turbine TT adjoins a compressor V, which has for example a low-pressure compressor 11 and a high-pressure compressor 12, and possibly also a medium-pressure compressor. The fan F on the one hand feeds air to the compressor V and on the other hand, for generating the thrust, feeds air to a secondary-flow or bypass duct B. The air conveyed via the compressor V ultimately passes into a combustion chamber section BK, in which the driving energy for driving the turbine TT is generated. For this purpose, the turbine TT has a high-pressure turbine 13, a medium-pressure turbine 14 and a low-pressure turbine 15. The energy released during the combustion is used by the turbine TT to drive the fan F in order then to generate the required thrust via the air conveyed into the bypass duct B. During this process, the air exits the bypass duct B in the region of an outlet A at the end of the engine T at which the exhaust gases flow outward out of the turbine TT. In this case, the outlet A usually has a thrust nozzle.

In principle, the fan F can also be coupled to the low-pressure turbine 15, and can be driven by the latter, via a connecting shaft and an epicyclic planetary transmission. It is furthermore also possible to provide other gas turbine engines of different design in which the proposed solution can be used. For example, engines of this type can have an alternative number of compressors and/or turbines and/or an alternative number of connecting shafts. As an example, the engine can have a split-flow nozzle, meaning that the flow through the bypass duct B has its own nozzle, which is separate from and situated radially outside the core engine nozzle. However, this is not limiting, and any aspect of the present disclosure may also apply to engines in which the flow through the bypass duct B and the flow through the core are mixed, or combined, before (or upstream of) a single nozzle, which may be referred to as a mixed-flow nozzle. One or both nozzles (whether mixed flow or split flow) may have a fixed or variable area. While the example described relates to a turbofan engine, the proposed solution may be applied for example to any type of gas turbine engine, such as an open-rotor engine (in which the fan stage is not surrounded by an engine nacelle) or a turboprop engine.

In the variant illustrated by way of example in the present case of an engine T, the turbine TT comprises multiple rows of turbine rotors and (turbine) stators, which rows are arranged one behind the other in an axial direction. The rows of turbine rotors, which rotate about the central axis M, and the rows of stationary stators are arranged in an alternating manner along the central axis M and are accommodated in a housing G of the turbine TT, in particular for example in the region of the high-pressure turbine 13 or of the low-pressure turbine 15.

FIG. 1 shows, in a detail, the turbine TT, for example in the region of the high-pressure turbine 13, with a stator 2, at which a guide vane 22 is arranged in an annular space RR of the turbine TT upstream of a turbine rotor blade 3. The stator 2 is fixed to the housing G of the turbine TT via a radially outer platform 20, which forms a head plate of the stator 2.

A hollow space in the form of a platform cavity 4a is formed between a section of the housing G and the outer platform 20. A pressure p1 and a temperature T1 prevail in said platform cavity 4a. The platform cavity 4a is fluidically connected via a flow-guiding element in the form of a chamber component 5 to the annular space RR such that, at a pressure p2 or p3 in the annular space RR, which is lower than the pressure p1 in the platform cavity 4a, a target flow, f1 or f3, of air flows from the platform cavity 4a in the direction of the annular space RR. Here, the chamber component 5 of the design variant in FIG. 1 provides for this purpose two outflow openings 502 and 510 for the fluidic connection to the annular space RR. A first outflow opening 502 is in this case provided in the region of the radially outer platform 20 in a region via which fluid of the target flow f3, which fluid flows out of the first outflow opening 502, passes between the guide vane 22 and the turbine rotor blade 3. By contrast, the second outflow opening 510 is provided at the foot of the guide vane 22 upstream of the first outflow opening 502. The first outflow opening 502 is provided at a prechamber 50 of the chamber component 5, into which prechamber fluid can flow from the platform cavity 4a via a throttling inlet opening 503 of the chamber component 5. A flow duct 51 of the chamber component 5 is connected via a connection opening 501 to said prechamber 50 and in turn connects the prechamber 50 to the second outflow opening 510.

During malfunction-free operation of the engine T, an (intermediate) pressure p4 is set in the prechamber 50, which, though—owing to the throttling action of the inlet opening 503—it is lower than the pressure p1 in the platform cavity 4a, is higher than a pressure p3 in the annular space RR at the first outflow opening 502 and is also higher than a pressure p2 in the annular space RR in the region of the second outflow opening 510. In this way, via the pressure gradients between p4 and p2 (Δp42) and p4 and p3 (Δp43), respectively, the target flows f1 and f3 from the platform cavity 4a in the direction of the annular space RR are generated during malfunction-free operation of the engine T. One target flow f3 is in this case conducted from the platform cavity 4a and—flowing into the prechamber 50 via the inlet opening 503—through the first outflow opening 502 in the direction of the annular space RR. The other target flow f1, with fluid originating from the platform cavity 4a, is, driven by the pressure gradient between the pressure p4 in the prechamber 50 and the pressure p2 at the second outflow opening 510, conducted through the flow duct 510 in the direction of the annular space RR.

At least one temperature sensor S, which is connected to an electronic evaluation unit AE via a sensor line SL, is arranged in the flow duct 51. Consequently, during malfunction-free normal operation, the target flow f1 is guided past the temperature sensor S via the chamber component 5. Said target flow f1 carries along fluid of temperature T1 from the platform cavity 4a and thus fluid which is cooler by several 100 K than the fluid of temperature T2 in the annular space RR of the turbine TT.

If then a malfunction occurs during operation of the engine T, in particular in a feed for the cooling air into the platform cavity 4a, there is a drop in the (relatively high) pressure p1 in the platform cavity 4a and thus also in the pressure p4 in the prechamber 50 of the chamber component 5. In this case, the (intermediate) pressure p4 in the prechamber 50 can drop to such an extent that the pressure p2 at the second outflow opening 510 at the foot of the stator 2 is higher than the pressure p4 in the prechamber 50. A fault flow f2 within the flow duct 51 is thus formed and guides hot fluid of above 1000 K from the annular space RR to the first outflow opening 504 via the prechamber 50 (since the pressure p3 at the first outflow opening 504 situated downstream is still higher than the pressure p2 at the second outflow opening 510). A fault flow f2 across the temperature sensor S in the flow duct 51 is thus formed, which replaces the target flow f1 present during normal operation. Here, the fault flow f2 then also flows counter to the flow direction of the target flow f1.

Due to relatively hot fluid being carried along from the annular space RR, a considerable jump in temperature is able to be measured at the temperature sensor S in the event of the occurrence of the fault flow f2. Via evaluation logic means of the electronic evaluation unit AE, a malfunction in the feeding of the cooling air into the platform cavity 4a is able to be detected via said jump in temperature. Such a detection can then directly lead to the generation of an alarm signal since, in the case of reduced or even no feeding of cooling air, there is a risk of failure of thermally highly loaded components of the turbine TT.

In the illustrated solution in FIG. 1, use is consequently made of the fact that, in the event of any malfunction in the feeding of cooling air in the region of a guide vane 22 of a stator 2, flow reversal occurs in a flow duct 51 of a flow-guiding element, formed here by way of example as a chamber component 5, in which a temperature sensor is arranged. Due to the reversal of flow direction, guidance past the temperature sensor S of hot air from the annular space RR instead of relatively cool air in the direction of the annular space RR is realized. The associated clearly measurable rise in temperature can then be used directly for the fault diagnosis and the generation of an alarm signal.

In the design variant in FIG. 2, provision is again made of a chamber component 5 as a flow-guiding element in a platform cavity 4a at an upper platform 20 of the stator 2. Here too, the chamber component 5 forms a prechamber 50. However, said prechamber 50 is in this case fluidically connected via a throttle section 52 to an additional chamber 53, situated upstream, of the chamber component 5 such that, during malfunction-free normal operation of the engine T, pressure conditions which are similar to those in the design variant in FIG. 1 prevail and, in particular, target flows f1 and f2 via which fluid is conducted from the platform cavity 4a across an inlet opening 503 at the prechamber 50 to first and second outflow openings 502 and 504 at the prechamber 50 and the additional chamber 53 in the direction of the annular space RR are established.

In the event of a malfunction in the feeding of cooling air into the platform cavity 4a and the associated changing pressure conditions, in this design variant too, a fault flow f2 flows over the temperature sensor S arranged in the region of the throttle section 52. Said fault flow f2 guides relatively hot fluid from the annular space RR to the first outflow opening 502 via the second outflow opening 504.

Both the chamber component in FIG. 1 and the chamber part 5 in FIG. 2 may be formed integrally on the guide vane 22 of the stator 2 and, in this case, on a cover surface which faces the platform cavity 4a. Alternatively, the chamber component 5 may be molded onto the stator 2, for example welded onto the cover surface, at a later stage, which cover surface, with the stator 2 in the state in which it is installed as intended, faces toward the platform cavity 4a and borders the latter. In the design variant in FIG. 2, the cover surface already forms in this case for example passage openings 20a, 20b by way of which the chamber component-side outflow openings 502 and 504 are brought into alignment during the mounting of the chamber component 5 onto the guide vane 22.

In principle, the chamber component 5 may be of box-shaped form, with the result that tubular flow ducts are avoided and the chamber component 5 is formed to be more robust.

In the design variant in FIG. 3, the chamber component 5 is provided within the (upper) platform cavity 4a of a guide vane 22 of the turbine TT and is of duct-like form. Here, the chamber component 5 extends in a substantially L-shaped manner between an inlet opening 503, which is situated within the platform cavity 4a, and an outflow opening 504, which provides the fluidic connection to the annular space RR.

In this case, a fluidic connection is provided between a vane chamber 220 in the interior of the guide vane 22 and the annular space RR via the chamber component 5. The vane chamber 220 passes through the guide vane 22 in a radial direction and permits the feeding of a cooling-air flow, for example by way of bleed air, controlled via corresponding valves, from the compressor V of the engine T, from radially at the outside in the direction of the interior of the turbine TT. During malfunction-free operation of the engine T, the higher pressure in the platform cavity 4a in comparison with the pressure in the annular space RR gives rise to a target flow, with branched-off cooling air from the interior of the guide vane 22, through the duct-like chamber component 5 in the direction of the annular space RR. Here, the corresponding target flow f1 is again conducted over a temperature sensor S which is positioned in the chamber component 5. If the pressure within the guide vane 22 drops owing to a malfunction in the cooling-air supply, fluid which is hotter by several 100 K flows, via the chamber component 5, from the annular space RR into the platform cavity 4a and past the temperature sensor S. A corresponding jump in temperature that is associated with the flow switch can therefore be easily detected and used for generating an alarm signal.

In the design variant in FIG. 4, a flow-guiding element of tubular design in the form of a flow duct 6 likewise projects into an (upper) platform cavity 4a of the stator 2. The annular space RR is fluidically connected to the platform cavity 4a via said flow duct 6. For this purpose, the flow duct 6 has a T-shaped extent and forms two duct sections 61 and 62 which project transversely into the platform cavity 4a and which open into a common duct section 60 which is connected via an outflow opening 600 to the annular space RR at the head plate of the stator 2.

Each of the duct sections 61 and 62, projecting into the platform cavity 4a, of the T-shaped and thus branched flow duct 6 has an inflow opening 610 or 620. It is possible via said inflow openings 610, 620 for cooler fluid to flow from the platform cavity 4a into the flow duct 6 in the direction of the annular space RR if the pressure within the platform cavity 4a is higher than the pressure in the annular space RR at the outflow opening 600.

The relatively high pressure in the platform cavity 4a that prevails during malfunction-free normal operation arises as a result of fed cooling air, which is conducted into the platform cavity 4a and in the direction of the stator 2 via one or more feed ducts FP at the housing G. During malfunction-free operation of the engine T, target flows f1 and f3 are thereby established in the direction of the annular space RR.

In the event of any malfunction, fault flows f2a and f2b are, by contrast, formed, which conduct fluid from the annular space RR into the flow duct 6 via the outflow opening 600 and, from said flow duct, into the platform cavity 4a via the inflow openings 610, 620. In the event of fault flows f2a, f2b being established, a temperature sensor S arranged in the common duct section 60 thereby experiences a measurable rise in temperature, which can be evaluated as an indication of a potential malfunction in the engine T.

As illustrated schematically in FIG. 4, the temperature sensor S may be connected to a sensor tube via which a sensor line SL or multiple sensor lines SL are led from the guide vane 22 outward to an electronic evaluation unit AE.

FIGS. 5A, 5B and 5C illustrate by way of example further possible design variants for the design of a flow duct 6 according to FIG. 4.

Here, the design variant in FIG. 5A provides for example that the flow duct 6 extends in a radial direction in a tubular and rectilinear manner. In the design variant in FIG. 5B, the flow duct 6 is, by contrast, of L-shaped form for the purpose of deflecting the fluid flows. The design variant in FIG. 5C in turn has, by contrast with the design variants in FIGS. 4, 5A and 5B, the temperature sensor S not provided within the flow duct 6. It is rather the case here that, for the flow duct 6 formed in an L-shaped manner by way of example, the temperature sensor S is arranged adjacent to the inflow opening 610, albeit outside the flow duct 6. In any case, however, in this variant too, the temperature sensor S is positioned such that both the target flow f1 and the fault flow f2 are conducted past the temperature sensor S and consequently the temperature sensor S is situated in a flow path both of the target flow f1 and of the fault flow f2.

FIG. 6 shows, in a perspective view and by way of example, a guide vane 22 as may be used in the design variants mentioned above and below. The guide vane 22 in FIG. 6 has a vane chamber 220 which passes centrally through the guide vane 22. Via an inflow opening 220a at the outer platform 20 and thus the head plate of the guide vane 22, a cooling target flow f1 can flow into the vane chamber 220 (from which, during normal operation, the target flow then also emerges in the direction of the annular space RR). With the guide vane 22 in the state in which it is installed as intended, said cooling target flow f1 exits at an outflow opening 220b in the direction of the interior of the turbine TT. The outflow opening 220b is in this case formed at an inner platform 21 and, with this, at a foot plate of the guide vane 22.

In the refinement in FIG. 7, provision is made of a flow-guiding element in the form of a flow duct 7 via which a fluidic connection is provided between a platform cavity 4b provided at the inner platform 21 and a vane chamber at the guide vane 22. During malfunction-free operation of the engine T, a pressure gradient via which a target flow f1 flows through the flow duct 7 from a vane chamber-side inflow opening 71 to a cavity-side outflow opening 72 prevails at the guide vane 22.

In the event of an impairment or even a failure of feeding of cooling air to the guide vane 22, the pressure conditions change locally such that, instead of the target flow f1, a fault flow f2 flows, in the reversed flow direction, through the flow duct 7. A temperature sensor S arranged in a region of the inflow opening 71 is then exposed to the relatively hot fluid of the fault flow f2.

The platform cavity 4b in FIG. 7 may be a so-called Jenkinson cavity or a rotor pressure-damping cavity. In the event of a fault, the fault flow f2 does not in this case lead to the creation of a direct hot-gas path. Rather, the fault flow f2 carries along mixed air which merely contains hot gas, albeit being hot enough in this way to result in an abrupt rise in the temperature measured at the temperature sensor S.

Furthermore, FIGS. 7a and 7b illustrate, with additional details, a design of a platform cavity 4b* as a Jenkinson cavity or rotor pressure-damping cavity. Here, in FIG. 7A, the platform cavity 4b* is formed between a rotor blade 3* arranged upstream and the inner platform 21 of the guide vane 22, wherein the platform cavity 4b* is axially bordered on the one hand (upstream) by a blade foot 30 and/or a rotor disk 31 of the rotor blade 3* and on the other hand (downstream) by the inner platform 21 of the guide vane 22. For the purpose of reducing or avoiding disruptive leakage flows, in the direction of the annular space RR, provision is made for an edge seal 32 at the rotor blade platform and, radially further inward, a spatial separation with respect to a radially further inwardly formed hollow space H. In contrast to this, the design variant in FIG. 7B, in addition to the (outer) edge seal 32, provides radially further inwardly a further (inner) edge seal 33 for bordering the platform cavity 4b* formed as a Jenkinson cavity or rotor pressure-damping cavity.

Furthermore, yet a further variant for an orientation of the flow duct 7 is, in each case by dashed lines, also illustrated in FIGS. 7, 7A and 7B. In this case, the flow duct 7 opens at another position into one (of multiple) platform cavities 4b provided on the circumference.

In the design variant in FIGS. 8A and 8B, a fluidic connection is provided between the annular space RR and an inner vane chamber 220 of a guide vane 22 of the turbine TT via a tubular flow duct 7 as a flow-guiding element. Here, FIG. 8A shows a side view of the guide vane 22, while FIG. 8B shows a sectional view along the section line Z-Z in FIG. 8A.

The tubular flow duct 7 extends into the vane chamber 220 in the interior of the guide vane 22 such that, during malfunction-free operation of the engine T, the prevailing pressure conditions result in fluid being able to flow from the interior of the guide vane 22 in the direction of the annular space RR via an inner opening 73b of the flow duct 7 and being able to flow out at an opening 73a provided on the suction side of the guide vane 22.

If a pressure within the vane chamber 220 is reduced owing to impaired feeding of cooling air, the changed pressure conditions can result in the occurrence of a fault flow f2. The fault flow f2 guides fluid into the flow duct 7 via the opening 73a, through the flow duct 7, and into the vane chamber 220 via the inner opening 73b. The relatively hot fluid from the annular space RR is then guided past a temperature sensor S arranged in the flow duct 7, whereby a malfunction in the engine T, more precisely also a malfunction in the feeding of the cooling air, can be inferred.

In deviation from the illustration in FIGS. 8A and 8B, an opening of the flow duct 7 may of course also be provided on a pressure side of the guide vane 22.

In the design variant in FIG. 9, an integrally formed or molded-on chamber component 8 is provided as a flow-guiding element at a radially inner platform 21 of a guide vane 22. Via the chamber component 8 in FIG. 9, a fluidic connection is provided between the annular space RR and an inner platform cavity 4b in the region of a foot plate of the guide vane 22.

During malfunction-free operation of the engine T, it is also the case here that fluid flows from the platform cavity 4b, which is fed with cooling air, in the direction of the annular space RR. Here, a corresponding target flow f1 with fluid of a (relatively low) temperature T1 flows via an inflow opening 80, situated within the platform cavity 4b, of the chamber component 8 through an outflow opening 81 at the foot of the guide vane 22 and into the annular space RR. If a pressure p1 in the platform cavity 4b drops, in particular below a pressure p2 within the annular space RR, relatively hot fluid of the (relatively high) temperature T2 (with AT in the region of 500 K for example) flows, by way of a fault flow f2, from the annular space RR into the platform cavity 4b via the outflow opening 81 and the inflow opening 80. Here too, a temperature sensor S arranged in the chamber component 8 then detects a considerable jump in temperature and thus automatically reliably permits the generation of an alarm signal in the event of the occurrence of a malfunction.

In the design variants in FIGS. 10A and 10B, a flow-guiding element in the form of a sensor head 90 of a sensor unit 9 is inserted at a borescope opening BO. Here, the sensor head 9 is sealingly inserted into a passage opening 201 at the head of the guide vane 22. The sensor head 90 has in this case a sealing sealing body D1. In the exemplary embodiment illustrated in FIGS. 10A and 10B, the sensor head 90 is provided for example at the end of a sensor arm 91 which is fixed via a fastening body 9a to the borescope opening BO of the housing G by a screwed connection. Via the fastening body 9a, it is then also possible for one or more sensor lines SL to be led outward to an electronic evaluation unit which receives temperature signals of the temperature sensor S. The sealing of the housing-side borescope opening BO is ensured by a further sealing body D2 at the sensor arm 91. The fact that, in the present case, the sensor head 90 is inserted in a borescope opening BO which is to be provided in any case for maintenance purposes means that, for example, it is possible to reduce considerably any modifications to the guide vane 22 for implementing the proposed solution.

For the detection of a malfunction within the engine T and in particular a malfunction in the feeding of cooling air in the region of the guide vane 22, the sensor head 90 has multiple openings 900, 901a and 901b for conducting fluid flows f1, f2. In this case there is, via an outlet opening 900, a fluidic connection to the annular space RR, a main flow f for rotating the turbine TT being guided in said annular space. Via inflow opening 901a, 901b, there is in turn a fluidic connection to the radially external outer space at the housing G and/or a radially outer platform cavity 4a of the stator 2.

During malfunction-free operation of the engine T, here too, a target flow f1 is guided in a pressure-driven manner across a temperature sensor S arranged in the sensor head 90, specifically from the inflow openings 901a, 901b to one or more outlet openings 900. In any malfunction situation, a fault flow f2 with relatively hot fluid, by contrast, flows in the opposite direction from the annular space RR outward via the openings 900 and 901a, 901b.

FIG. 11 illustrates on the basis of an exemplary flow diagram the implementation of a design variant of a proposed method for the detection of any malfunction at the engine T. For example, the method can in this case be realized with the aid of one of the aforementioned exemplary embodiments of a sensor system, which comprises at least one flow-guiding element 5, 6, 7, 8 or 90 and at least one temperature sensor S.

In the context of an exemplary embodiment of the proposed method, for example, in a first step A1, a temperature signal delivered from the temperature sensor S is monitored continuously. If, owing to changing local pressure conditions, a fault flow f2, f2a or f2b is generated, by way of which relatively hot fluid is guided past the temperature sensor S, with the aid of evaluation logic means of an electronic evaluation unit AE, which receives the temperature signal from the at least one temperature sensor S, in a method step A2, the presence of a malfunction in the engine T is signalized.

In this case, it is also possible for example to evaluate, via the electronic evaluation unit AE on the basis of the magnitude of a measured temperature or of a measured rise in temperature, whether the detected malfunction is possibly a critical functional impairment or a less critical functional impairment, for example whether the feeding of the cooling air has merely been reduced or else has completely failed.

### LIST OF REFERENCE SIGNS

11 Low-pressure compressor
12 High-pressure compressor
13 High-pressure turbine
14 Medium-pressure turbine
15 Low-pressure turbine
2 Turbine stator
20 Outer platform
201 Passage opening
20a, 20b Passage opening
21 Inner platform
22 Guide vane
220 Vane chamber (hollow space)
220a Inflow opening
220b Outflow opening
3, 3* Turbine rotor blade
30 Blade foot
31 Rotor disk
32 Outer edge seal
33 Inner edge seal
4a, 4b, 4b* Platform cavity (hollow space)
5 Chamber component (flow-guiding element)
50 Prechamber
501 Connection opening
502 First outflow opening
503 Inlet opening
504 (Second) outflow opening
51 Flow duct
510 Second outflow opening
52 Throttle section
53 Additional chamber
6 Flow duct (flow-guiding element)
60 Duct section
600 Outflow opening
61 Duct section
610 Inflow opening
62 Duct section
620 Inflow opening
7 Flow duct (flow-guiding element)
70 Sensor tube
71 Inflow opening
72 Outflow opening
73a Opening on suction side
73b Inner opening
8 Chamber component (flow-guiding element)
80 Inflow opening
81 Outflow opening
9 Sensor unit
90 Sensor head (flow-guiding element)
900 Outflow opening
901a, 901b Inflow opening
91 Sensor arm
9a Fastening body
A Outlet
AE Electronic evaluation unit
B Bypass duct
BK Combustion chamber section
BO Borescope opening
D1, D2 Sealing body
E Inlet/Intake
F Fan
f Main flow
f1, f3 Target flow
f2, f2a, f2b Fault flow
FP Feed duct
H Hollow space
G Housing
M Central axis/axis of rotation
p1, p2, p3, p4 Pressure
R Inlet direction
RR Annular space
S Temperature sensor
SL Sensor line
T Gas turbine engine
T1, T2 Temperature
TT Turbine
V Compressor

1. An engine having
at least one flow-guiding element within the engine, via which, during malfunction-free operation of the engine, at least one target flow of fluid is conducted along a first flow direction and via which, in the event of a malfunction within the engine, a fault flow of fluid of a higher temperature than the fluid of the target flow is conducted along a second flow direction, which differs from the first flow direction, and
at least one temperature sensor which is situated in a flow path both of the target flow and of the fault flow.

2. The engine according to claim 1, wherein the at least one temperature sensor is positioned at or in the at least one flow-guiding element.

3. The engine according to claim 1, wherein the flow-guiding element is designed to guide the fault flow past the at least one temperature sensor along a second flow direction, which is opposite the first flow direction of the target flow.

4. The engine according to claim 1, wherein the at least one flow-guiding element is formed with at least one flow duct via which the target flow and/or the fault flow are/is diverted at least once.

5. The engine according to claim 1, wherein the at least one flow-guiding element is provided in the region of a stator of a turbine of the engine.

6. The engine according to claim 5, wherein, via the at least one flow-guiding element, the target flow is conducted from a hollow space, which is bordered at least partially by the stator, in the direction of an annular space of the engine, in which at least one guide vane of the stator is arranged.

7. The engine according to claim 6, wherein the hollow space is formed at least partially in the interior of the guide vane.

8. The engine according to claim 6, wherein the hollow space is formed at least partially between a platform of the stator and a section of a housing to which the stator is fixed.

9. The engine according to claim 6, wherein the hollow space is connected to at least one feed duct via which, during the operation of the engine, fluid is fed to the hollow space, and the flow-guiding element is configured to conduct a fault flow, which is formed, along the second flow direction if the quantity of the fluid fed via the at least one feed duct drops below a threshold value.

10. The engine according to claim 6, wherein, via the at least one flow-guiding element, the fault flow is conducted from the annular space of the engine in the direction of the hollow space which is bordered at least partially by the stator.

11. The engine according to claim 6, wherein an opening via which fluid is able to flow into the annular space and/or out of the annular space is provided at a radially outer platform of the stator, at a radially inner platform of the stator and/or at a guide vane of the stator.

12. The engine according to claim 5, wherein the at least one flow-guiding element is formed with a chamber and/or a throttle section.

13. The engine according to claim 5, wherein the at least one flow-guiding element is formed integrally on a guide vane of the stator.

14. The engine according to claim 1, wherein the at least one flow-guiding element is provided at a borescope opening.

15. A method for the electronic detection of a malfunction during the operation of an engine, wherein at least one temperature sensor is positioned within the engine in a flow path along which, during malfunction-free operation of the engine, at least one target flow of fluid flows along a first flow direction and along which, in the event of a malfunction within the engine, a fault flow of fluid of a higher temperature flows along a second flow direction, which differs from the first flow direction, and, by way of a switch from the target flow to the fault flow and an associated jump in temperature which occurs at the at least one temperature sensor, a malfunction is detected electronically.

16. The method according to claim 15, wherein the method is carried out at an engine according to claim 1.
